(19) United States
(12) Patent Application Publication
(10) Pub. No.: US 2026/0128420 A1
(43) Pub. Date: May 7, 2026

(54) HEAT INSULATING SHEET FOR RECHARGEABLE LITHIUM BATTERY AND RECHARGEABLE LITHIUM BATTERY MODULE INCLUDING THE SAME

(71) Applicant: SAMSUNG SDI CO., LTD., Yongin-si (KR)

(72) Inventors: Jung Hyo LEE, Suwon-si (KR); Myung Heui WOO, Suwon-si (KR); Seung Yong YANG, Suwon-si (KR); Hye Jin PARK, Suwon-si (KR); Jae Hyun LEE, Suwon-si (KR); Ha Na RA, Suwon-si (KR); Kang Won LEE, Suwon-si (KR); Yun Sung YANG, Suwon-si (KR)

(21) Appl. No.: 19/376,757

(22) Filed: Oct. 31, 2025

(30) Foreign Application Priority Data
Nov. 1, 2024 (KR) 10-2024-0153536

(51) Int. Cl. H01M 10/658; B32B 5/02; B32B 9/04; B32B 17/06; B60L 50/64; H01M 10/052; H01M 10/625; H01M 10/647; H01M 50/209; H01M 50/293

(52) U.S. Cl. CPC H01M 10/658; B32B 5/02; B32B 9/04; B32B 17/06; H01M 10/052; H01M 10/625; H01M 10/647; H01M 50/209; H01M 50/293; B32B 2255/02; B32B 2255/20; B32B 2307/304; B32B 2307/718; B32B 2307/7376; B32B 2457/10; B60L 50/64; H01M 2220/20

(57) ABSTRACT

A heat insulating sheet for a rechargeable lithium battery and a rechargeable lithium battery module are disclosed. A heat insulating sheet includes a substrate sheet including a first substrate layer, an aerogel-containing layer, and a second substrate layer, which are sequentially laminated; and a coating layer surrounding the substrate sheet, and each of the first substrate layer and the second substrate layer includes one selected from the group consisting of a glass fiber sheet having a weight of 70 to 500 grams per square meter (gsm); and a carbon fiber sheet having a weight of 50 to 300 gsm, each of the first substrate layer and the second substrate layer has a thickness of 300 μm to 5,000 μm, the aerogel-containing layer has a thickness of 300 μm to 5,000 μm, and the aerogel is included in an amount of 10 to 90% by weight in the aerogel-containing layer.

### CROSS-REFERENCE TO RELATED APPLICATION

The present application claims priority to and the benefit of Korean Patent Application No. 10-2024-0153536, filed on Nov. 1, 2024 in the Korean Intellectual Property Office, the entire disclosure of which is incorporated herein by reference.

### BACKGROUND

### 1. Field

Aspects of embodiments of the present invention relate to a heat insulating sheet for a rechargeable lithium battery and a rechargeable lithium battery module including the same.

### 2. Description of the Related Art

In recent years, with the rapid spread of electronic devices using batteries, such as mobile phones, laptop computers, electric vehicles, and the like, the demand for secondary batteries with high energy density and high capacity has rapidly increased. Accordingly, research and development for improving the performance of rechargeable lithium batteries is actively underway.

A rechargeable lithium battery is a battery that includes positive and negative electrodes that include active materials capable of intercalation and deintercalation of lithium ions, and an electrolyte, and produces electrical energy through oxidation and reduction reactions when the lithium ions are intercalated/deintercalated into/from the positive and negative electrodes.

A plurality of rechargeable lithium batteries may be included to form a rechargeable lithium battery module.

In the rechargeable lithium battery module, it may be desirable to block heat propagation and/or heat transfer between adjacent cells.

### SUMMARY

According to an aspect of embodiments of the present invention, a heat insulating sheet for a rechargeable lithium battery having excellent heat insulating properties, flexibility, compressibility, dust resistance, heat resistance, and durability is provided.

According to another aspect of embodiments of the present invention, a rechargeable lithium battery module including the above-described heat insulating sheet for a rechargeable lithium battery is provided.

According to one or more embodiments, a heat insulating sheet for a rechargeable lithium battery includes a substrate sheet including a first substrate layer, an aerogel-containing layer, and a second substrate layer, which are sequentially laminated; and a coating layer surrounding the substrate sheet, wherein each of the first substrate layer and the second substrate layer includes one selected from the group consisting of a glass fiber sheet having a weight of 70 to 500 grams per square meter (gsm); and a carbon fiber sheet having a weight of 50 to 300 gsm, and each of the first substrate layer and the second substrate layer has a thickness of 300 μm to 5,000 μm, the aerogel-containing layer has a thickness of 300 μm to 3,000 μm, and the aerogel is included in an amount of 10 to 90% by weight in the aerogel-containing layer.

According to one or more embodiments, a rechargeable lithium battery module includes a plurality of battery cells arranged to face each other; and the heat insulating sheet for a rechargeable lithium battery disposed between the plurality of battery cells.

The heat insulating sheet for a rechargeable lithium battery according to one or more embodiments may provide excellent insulating properties, and thus may suppress heat propagation and/or heat transfer within the module, thereby improving the safety of a module.

The heat insulating sheet for a rechargeable lithium battery according to one or more embodiments may provide excellent flexibility and compressibility, thereby improving the manufacturing processibility of the heat insulating sheet and the battery module.

The heat insulating sheet for a rechargeable lithium battery according to one or more embodiments may provide excellent dust resistance, thereby improving the manufacturing processibility of the heat insulating sheet and the battery module.

The heat insulating sheet for a rechargeable lithium battery according to one or more embodiments may provide excellent heat resistance and durability, thereby improving a lifespan of the battery module.

### BRIEF DESCRIPTION OF THE DRAWINGS

FIG. 1 is a cross-sectional view of a heat insulating sheet for a rechargeable lithium battery according to an embodiment.

FIG. 2 is a perspective view of a rechargeable lithium battery module according to an embodiment.

FIG. 3 is an exploded perspective view of the rechargeable lithium battery module of FIG. 2.

FIG. 4 is a cross-sectional view schematically showing a battery cell according to an embodiment.

FIG. 5 is a perspective view schematically showing a battery pack according to an embodiment.

FIG. 6 is a perspective view schematically showing a battery pack according to an embodiment.

FIG. 7 is a drawing showing a car body and car body parts according to an embodiment.

FIG. 8 is a drawing showing a car body and car body parts according to an embodiment.

### DETAILED DESCRIPTION

Herein, some embodiments of the present invention will be described in further detail. However, it is to be understood that these embodiments are presented as examples and are not intended to limit the present invention, and the present invention is defined by the scope of the claims.

Unless otherwise particularly stated in the present specification, a case in which a part, such as a layer, a film, a region, a plate, or the like is “on” another part includes not only a case in which the part is “directly on” another part, but also a case in which there is another part interposed therebetween.

Unless otherwise particularly stated in the present specification, a singular form may also include a plural form. In addition, the term “A or B” may mean “including A, including B, or including A and B” unless otherwise particularly stated herein.

In the present specification, the term “combination thereof” may refer to a mixture, a laminate, a composite, a copolymer, an alloy, a blend, and a reaction product of compositions.

### Heat Insulating Sheet for Rechargeable Lithium Battery

A heat insulating sheet for a rechargeable lithium battery according to an embodiment includes a substrate sheet including a first substrate layer, an aerogel-containing layer, and a second substrate layer, which are sequentially laminated; and a coating layer surrounding the substrate sheet, wherein each of the first substrate layer and the second substrate layer includes one selected from the group consisting of a glass fiber sheet having a weight of 70 to 500 grams per square meter (gsm); and a carbon fiber sheet having a weight of 50 to 300 gsm, each of the first substrate layer and the second substrate layer has a thickness of 300 μm to 5,000 μm, the aerogel-containing layer has a thickness of 300 μm to 5,000 μm, and the aerogel is included in an amount of 10 to 90% by weight in the aerogel-containing layer. In an embodiment, the heat insulating sheet includes the aerogel-containing layer and the substrate layer, and the heat insulating sheet may provide excellent heat insulating properties, dust resistance, heat resistance, and durability. Both the aerogel-containing layer and the substrate layer may contribute to improving the heat insulating properties, dust resistance, heat resistance and durability of the heat insulating sheet.

Herein, the heat insulating sheet according to an embodiment will be described in further detail.

### Substrate Sheet

A substrate sheet includes a first substrate layer, an aerogel-containing layer, and a second substrate layer, which are sequentially laminated.

### First Substrate Layer

The first substrate layer supports the aerogel-containing layer and the second substrate layer in the heat insulating sheet.

The first substrate layer may include at least one layer, that is, one layer or two or more layers, in the heat insulating sheet.

In an embodiment, the first substrate layer includes one selected from the group consisting of a glass fiber sheet having a weight of 70 to 500 gsm, for example, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500 gsm, 80 to 200 gsm, or 90 to 120 gsm; and a carbon fiber sheet having a weight of 50 to 300 gsm, for example, 50, 60, 70, 80, 90, 100, 110, 120, 130, 140, 150, 160, 170, 180, 190, 200, 210, 220, 230, 240, 250, 260, 270, 280, 290, 300 gsm, 50 to 200 gsm, or 70 to 150 gsm.

The glass fiber sheet may generally be supplied in the form of a glass fiber fabric or mat, and may be used to manufacture a heat insulating sheet by laminating the glass fiber sheet on a substrate layer. During the lamination process, the glass fibers are combined with a resin such as to be converted into a composite material having high strength and high heat resistance, and the laminated sheet may be cured at high temperatures (a curing process) to enhance strength and heat resistance.

The glass fiber sheet has electrical insulating and heat blocking properties and an easy manufacturing process, and may be easily processed into various shapes. Also, the glass fiber sheet has a uniform thickness and structure, is highly resistant to chemicals, is flexible, and has heat resistance and stability at high temperatures.

The glass fiber sheet may include, for example, at least one of E-glass, S-glass, C-glass, ECR-glass, AR-glass, and D-glass.

The carbon fiber sheet exhibits excellent thermal conductivity, and has heat resistance at high temperatures and high tensile strength, and thus may have structural safety. Also, the carbon fiber sheet is highly resistant to chemicals, has heat resistance at high temperatures, and may be easily processed into various shapes.

In an embodiment, the carbon fiber sheet may include at least one of polyacrylonitrile-based carbon fibers, pitch-based carbon fibers, and rayon-based carbon fibers.

In an embodiment, the first substrate layer may have a thickness of 300 μm to 5,000 μm, for example, 300, 400, 500, 600, 700, 800, 900, 1,000, 1,100, 1,200, 1,300, 1,400, 1,500, 1,600, 1,700, 1,800, 1,900, 2,000, 2,100, 2,200, 2,30, 2,400, 2,500, 2,600, 2,700, 2,800, 2,900, 3,000, 3,100, 3,200, 3,300, 3,400, 3,500, 3,600, 3,700, 3,800, 3,900, 4,000, 4,100, 4,200, 4,300, 4,400, 4,500, 4,600, 4,700, 4,800, 4,900, 5,000 μm, 500 μm to 4,000 μm, or 800 μm to 2,000 μm. Within the above range, the first substrate layer may be used in the heat insulating sheet.

### Aerogel-Containing Layer

The aerogel-containing layer may be a separate layer independent of the first substrate layer. Here, the term “independent separate layer” means that the aerogel-containing layer is not formed in the first substrate layer through impregnation or the like, but rather that the first substrate layer and the aerogel-containing layer are formed as completely separated non-continuous layers.

The aerogel-containing layer may include at least one layer, that is, one layer or two or more layers, in the heat insulating sheet.

The aerogel-containing layer includes a fibrous support, an aerogel, and a binder.

The fibrous support may be useful for supporting the aerogel-containing layer and improving the compressibility of the heat insulating sheet.

The fibrous support may be, for example, a wool mat or a chopped strand mat.

The fibers constituting the fibrous support may include at least one of natural fibers, glass fibers, carbon fibers, graphite fibers, mineral fibers, and polymer fibers. For example, the fibrous support may further improve compression characteristics thereof through the use of glass fibers.

The natural fibers may be fibers made of at least one of hemp, jute, flax, coir, kenaf, and cellulose. The mineral fibers may be fibers made of at least one of basalt, wollastonite, alumina, silica, slag, and rock. The polymer fibers may be fibers made of at least one of nylon; polyimide; polyamide; polybenzimidazole; polybenzoxazole; polyamideimide; a polyester, such as polyethylene terephthalate or polybutylene terephthalate; and a polyolefin, such as polyethylene or polypropylene.

In an embodiment, for example, the fibrous support may be glass wool.

The fibers in the fibrous support may have an aspect ratio of 1 or more, for example, 1 to 5,000. Within the above range, the aerogel-containing layer may be firmly formed, and the durability of the heat insulating sheet may be improved. Here, the term “aspect ratio” refers to a ratio of the length of the fibers to the diameter of the fibers in the fibrous support.

In an embodiment, the fibers in the fibrous support may have a length of 50 μm to 1,000 μm, for example, 70 μm to 800 μm, or 100 μm to 600 μm. Within the above range, the aerogel-containing layer may be firmly formed, and the durability of the heat insulating sheet may be improved.

In an embodiment, the fibers in the fibrous support may have a diameter of 0.1 μm to 20 μm, for example, 0.1 μm to 15 μm, 0.1 μm to 5 μm, 1 μm to 15 μm, or 3 μm to 10 μm. Within the above range, the aerogel-containing layer may be firmly formed, and the durability of the heat insulating sheet may be improved. Here, the term “diameter” refers to a diameter when the fibers have a circular cross-section, or may refer to the longest diameter if the cross-section of the fibers is not circular.

In an embodiment, the fibrous support is included in an amount of 5 to 70% by weight in the aerogel-containing layer. Within the above range, it may be easy to improve the durability of the heat insulating sheet. For example, the fibrous support may be included in an amount of 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70% by weight, 10 to 60% by weight, 25 to 60% by weight, or 25 to 50% by weight in the aerogel-containing layer. Within the above range, it may be easy to improve the flexibility and durability of the heat insulating sheet.

The aerogel may provide a heat insulating effect to the aerogel-containing layer.

According to an embodiment, the aerogel may have a specific surface area of 500 to 1,000 m²/g. For example, the specific surface area may be 500 to 950 m²/g, 550 to 950 m²/g, or 600 to 900 m²/g. Within the above range, it may be easy to prevent or substantially prevent heat transfer and heat propagation between a plurality of battery cells. Here, the term “specific surface area” may be a specific surface area obtained by Brunauer Emmett Teller (BET) specific surface area analysis.

According to an embodiment, the aerogel may have an average particle diameter of 5 μm to 200 μm. For example, the aerogel may have an average particle diameter of 10 μm to 100 μm or 20 μm to 50 μm. Within the above range, it may be easy to delay heat transfer between a plurality of battery cells by improving the heat insulation properties of the heat insulating sheet. Here, the term “average particle diameter” refers to an average particle diameter (D50) which represents the diameter of particles having a cumulative volume of 50% by volume in a particle diameter distribution. The average particle diameter (D50) may be measured by a method known to those skilled in the art, and may be, for example, measured by a particle diameter analyzer, a transmission electron micrograph, or measured using a scanning electron micrograph. As another method, the diameters of particles may be measured by a measuring device using dynamic light scattering, data analysis may be performed to count the number of particles for each particle diameter range, and the average particle diameter (D50) may be calculated therefrom. As another method, the average particle diameter (D50) may be measured using a laser diffraction method. If measured by the laser diffraction method, the particles to be measured may be dispersed in a dispersion medium, introduced into a commercially available laser diffraction particle diameter measuring device (e.g., Microtrac™ 3000), and irradiated at an output of 60 W using ultrasonic waves of approximately 28 KHz. Thereafter, the average particle diameter (D50) may be calculated based on 50% of the particle diameter distribution in the measuring device.

In an embodiment, the aerogel is included in an amount of 10 to 90% by weight in the aerogel-containing layer. Within the above range, it may be easy to improve the heat insulation properties of the heat insulating sheet. For example, the aerogel may be included in an amount of 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90% by weight, 30 to 70% by weight, 30 to 65% by weight, or 45 to 65% by weight in the aerogel-containing layer. Within the above range, the heat insulation properties of the heat insulating sheet may be improved.

The binder may improve compressibility and dust resistance of the heat insulating sheet.

According to an embodiment, the binder may be an aqueous binder. The aqueous binder has high solubility in water among the solvents as described below, and thus may be useful for forming an aerogel-containing layer.

According to an embodiment, the aqueous binder may include at least one of a cationic water-soluble polymer, an anionic water-soluble polymer, and a non-ionic water-soluble polymer.

The cationic water-soluble polymer is a polymer having a functional group, such as an amine group, an ammonium group, a phosphonium group, a sulfonium group, or a salt thereof. For example, the cationic water-soluble polymer may be a polymer having an amine group. For example, the cationic water-soluble polymer may include at least one of polyethyleneamine and polyamine.

The anionic water-soluble polymer is a polymer having a functional group such as a carboxylic acid group, a sulfonic acid group, an ester group, a phosphoric acid ester group, or a salt thereof. For example, the anionic water-soluble polymer may be a polymer having a carboxylic acid group. For example, the anionic water-soluble polymer may be polymaleic acid.

The non-ionic water-soluble polymer may include at least one of polyvinyl alcohol, polyethylene glycol, polyacrylamide, polyvinyl pyrrolidone, polyurethane, and polyester. The non-ionic water-soluble polymer may be a water-dispersible or water-soluble polymer.

According to an embodiment, the binder may include a mixture of one or more of polyvinyl alcohol, polyethylene glycol, polyacrylamide, and polyvinyl pyrrolidone; and one or more of polyurethane and polyester. In this case, it may be easy to provide the dispersion properties by one or more of polyvinyl alcohol, polyethylene glycol, polyacrylamide, and polyvinyl pyrrolidone, and the fire resistance properties by one or more of polyurethane and polyester. For example, a mixture of polyvinyl alcohol and polyurethane may be used.

According to an embodiment, the weight ratio of one or more of polyvinyl alcohol, polyethylene glycol, polyacrylamide, and polyvinyl pyrrolidone: one or more of polyurethane and polyester may be 1:1 to 1:5, for example, 1:1 to 1:4, or 1:2 to 1:3. Within the above range, the heat insulation properties, dust resistance, fire resistance, and mechanical properties of the heat insulating sheet may be improved.

In an embodiment, the binder is included in an amount of 0.5 to 20% by weight in the aerogel-containing layer. If the binder is included in an amount of 0.5% by weight or more, it may be easy to improve the dust resistance and durability of the heat insulating sheet. If the binder is included in an amount of 20% by weight or less, it may be easy to improve the durability of the heat insulating sheet. In an embodiment, for example, the binder may be included in an amount of 0.5, 1, 2, 3, 4, 5, 6, 7, 8, 9, 10, 11, 12, 13, 14, 15, 16, 17, 18, 19, 20% by weight, 2 to 15% by weight, or 5 to 10% by weight in the aerogel-containing layer. Within the above range, it may be easy to improve the dust resistance of the heat insulating sheet.

According to an embodiment, the fibrous support, the aerogel, and the binder may be included in a total of 95% by weight or more, for example, 95 to 100% by weight, 99 to 100% by weight, or 100% by weight in the aerogel-containing layer. Within the above range, it may be easy to achieve the effect of the heat insulating sheet.

The aerogel-containing layer may further include at least one of a dispersant and a silane-based compound.

The dispersant may improve the dispersion of the aerogel in a composition for the aerogel-containing layer, thereby enabling the preparation of an aerogel-containing layer in which the fibrous support and the aerogel are uniformly dispersed.

The dispersant may include at least one of a surfactant and a phosphorus salt. The surfactant may include at least one of a non-ionic surfactant, an anionic surfactant, and a zwitterionic surfactant. The surfactant may include at least one of a natural surfactant, such as lecithin and the like, and a non-natural surfactant, such as chemicals and the like. The phosphorus salt may be a phosphate-based salt.

The dispersant may be included in an amount of 0.1 to 6% by weight in the aerogel-containing layer. In an embodiment, for example, the dispersant may be included in an amount of 0.1 to 5% by weight or 0.1 to 3% by weight. Within the above range, the composition for the aerogel-containing layer may be prepared at a low cost, and a heat insulating sheet having further improved heat insulating properties, durability, and dust resistance may be provided.

According to an embodiment, the binder and the dispersant may be included in a weight ratio of 1:0.001 to 1:0.7, for example, 1:0.001 to 1:0.67, 1:0.001 to 1:0.5, or 1:0.001 to 1:0.3. If the binder and the dispersant are used together within the above range, they may enable the preparation of an aerogel-containing layer in which the aerogel is more uniformly dispersed.

The silane-based compound may improve the dispersibility of the aerogel in the aerogel-containing layer.

According to an embodiment, the silane-based compound may include at least one of an alkyl group-containing trialkoxysilane, such as methyltrimethoxysilane, methyltriethoxysilane, ethyltrimethoxysilane, ethyltriethoxysilane, octadecyltrimethoxysilane, and the like; an epoxy group-containing trialkoxysilane, such as glycidoxypropyltrimethoxysilane and the like; and an unsaturated group-containing trialkoxysilane, such as 3-(trimethoxysilyl)propylmethacrylate, and the like.

The aerogel-containing layer may further include a conventional additive known to those skilled in the art. The additive may include at least one of a wetting agent, an emulsifier, a compatibilizer, a viscosity modifier, a pH modifier, a stabilizer, an antioxidant, an acidic or alkaline scavenger, a metal deactivator, an anti-foaming agent, an antistatic agent, a thickener, an adhesion improver, a binder, a flame retardant, an impact modifier, a pigment, a dye, a colorant, and a deodorizing agent.

According to an embodiment, the aerogel-containing layer may have a thickness of 300 μm to 5,000 μm, for example, 300, 400, 500, 600, 700, 800, 900, 1,000, 1,100, 1,200, 1,300, 1,400, 1,500, 1,600, 1,700, 1,800, 1,900, 2,000, 2,100, 2,200, 2,30, 2,400, 2,500, 2,600, 2,700, 2,800, 2,900, 3,000, 3,100, 3,200, 3,300, 3,400, 3,500, 3,600, 3,700, 3,800, 3,900, 4,000, 4,100, 4,200, 4,300, 4,400, 4,500, 4,600, 4,700, 4,800, 4,900, 5,000 μm, 800 μm to 3,000 μm, or 1,500 μm to 2,200 μm. Within the above range, the aerogel-containing layer may be used in the heat insulating sheet.

The aerogel-containing layer may be formed using a composition for the aerogel-containing layer, which includes the fibrous support, the aerogel, and the binder. The composition for the aerogel-containing layer may further include at least one of the dispersant, the silane-based compound, and the additive.

In an embodiment, the composition for the aerogel-containing layer may include 5 to 70% by weight, for example, 10 to 60% by weight, 25 to 60% by weight, or 25 to 50% by weight, of the fibrous support; 10 to 90% by weight, for example, 30 to 70% by weight, 30 to 65% by weight, or 45 to 65% by weight, of the aerogel; and 0.5 to 20% by weight, for example, 2 to 15% by weight, or 5 to 10% by weight, of the binder, based on solid content.

A method of preparing the aerogel-containing layer will be described in further detail below.

### Second Substrate Layer

The second substrate layer may support the first substrate layer and the aerogel-containing layer in the heat insulating sheet.

The second substrate layer may include at least one layer, that is, one layer or two or more layers, in the heat insulating sheet.

The second substrate layer may be laminated on the aerogel-containing layer. The aerogel-containing layer may be a separate layer independent of the second substrate layer. Here, the term “independent separate layer” means that the aerogel-containing layer is not formed in the second substrate layer through impregnation or the like, but rather that the second substrate layer and the aerogel-containing layer are formed as completely separated non-continuous layers.

In an embodiment, the second substrate layer includes at least one selected from the group consisting of a glass fiber sheet having a weight of 70 to 500 gsm, for example, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500 gsm, 80 to 200 gsm, or 90 to 120 gsm; and a carbon fiber sheet having a weight of 50 to 300 gsm, for example, 50, 60, 70, 80, 90, 100, 110, 120, 130, 140, 150, 160, 170, 180, 190, 200, 210, 220, 230, 240, 250, 260, 270, 280, 290, 300 gsm, 50 to 200 gsm, or 70 to 150 gsm.

The glass fiber sheet may generally be supplied in the form of a glass fiber fabric or mat, and may be used to manufacture a heat insulating sheet by laminating the glass fiber sheet on a substrate layer. During the lamination process, the glass fibers are combined with a resin such as to be converted into a composite material having high strength and high heat resistance, and the laminated sheet may be cured at high temperatures (a curing process) to enhance strength and heat resistance. The resin may be originated from the binder of the aerogel-containing layer.

The glass fiber sheet has electrical insulating and heat blocking properties and an easy manufacturing process, and may be easily processed into various shapes. Also, the glass fiber sheet has a uniform or substantially uniform thickness and structure, is highly resistant to chemicals, is flexible, and has heat resistance and stability at high temperatures.

The glass fiber sheet may include, for example, at least one of E-glass, S-glass, C-glass, ECR-glass, AR-glass, and D-glass.

The carbon fiber sheet exhibits excellent thermal conductivity, and has heat resistance at high temperatures and high tensile strength, and thus may have structural safety. Also, the carbon fiber sheet is highly resistant to chemicals, has heat resistance at high temperatures, and may be easily processed into various shapes.

The carbon fiber sheet may include at least one of polyacrylonitrile-based carbon fibers, pitch-based carbon fibers, and rayon-based carbon fibers.

In an embodiment, the second substrate layer may have a thickness of 300 μm to 5,000 μm, for example, 300, 400, 500, 600, 700, 800, 900, 1,000, 1,100, 1,200, 1,300, 1,400, 1,500, 1,600, 1,700, 1,800, 1,900, 2,000, 2,100, 2,200, 2,30, 2,400, 2,500, 2,600, 2,700, 2,800, 2,900, 3,000, 3,100, 3,200, 3,300, 3,400, 3,500, 3,600, 3,700, 3,800, 3,900, 4,000, 4,100, 4,200, 4,300, 4,400, 4,500, 4,600, 4,700, 4,800, 4,900, 5,000 μm, 500 μm to 4,000 μm, or 800 μm to 2,000 μm. Within the above range, the second substrate layer may be used in the heat insulating sheet.

### Inorganic Layer

In an embodiment, the inorganic layer is formed on the entire surface of the substrate sheet. The inorganic layer may be formed on an upper surface of the substrate sheet, a lower surface opposite the upper surface, and a side surface connecting the upper surface and the lower surface.

According to an embodiment, the inorganic layer may be directly formed on the substrate sheet. Here, there term “directly formed” means that no pressure-sensitive adhesive layer, adhesive layer, or the like is formed between the substrate sheet and the inorganic layer.

The inorganic layer includes an inorganic material, and the inorganic material may include particles without any limitation as long as the particles have low thermal conductivity and may be stably fixed to each of the first substrate layer, the aerogel-containing layer, and the second substrate layer.

For example, the inorganic material may be a metal, a non-metal, an intermetallic compound or alloy, a non-metallic intermetallic compound or alloy, an oxide of the metal or non-metal, a fluoride of the metal or non-metal, a nitride of the metal or non-metal, a carbide of the metal or non-metal, an oxynitride of the metal or non-metal, a boride of the metal or non-metal, an oxyboride of the metal or non-metal, a silicide of the metal or non-metal, or a mixture thereof. In an embodiment, the metal or non-metal may be silicon (Si), aluminum (Al), selenium (Se), zinc (Zn), antimony (Sb), indium (In), germanium (Ge), tin (Sn), bismuth (Bi), a transition metal, a lanthanide metal, or the like, but the present invention is not limited thereto. In an embodiment, the inorganic material may be AlOₓ, In₂O₃, or SnO₂ including silicon oxide (SiOₓ), silicon nitride (SiNₓ), silicon oxynitride (SiOₓN_{y}), aluminum oxide (AlₓO_{y}), ZnSe, ZnO, Sb₂O₃, and the like.

In an embodiment, the inorganic material may include at least one of silicon oxide, for example, silica, and aluminum oxide, for example, alumina.

In an embodiment, the inorganic material may be in a spherical shape including any of a true spherical shape, an amorphous shape, a plate-like shape, a cubic shape, and the like.

In an embodiment, the inorganic material may have an average particle diameter of 0.005 μm to 10 μm, for example, 0.01 μm to 1 μm. Within the above range, it may be easy to form the inorganic layer.

The inorganic layer may further include a binder to facilitate coating of the inorganic material. The binder may include at least one of an aqueous binder and an organic binder as long as the binder does not affect the above-described effects of the heat insulating sheet.

In an embodiment, the binder may be at least one of polyvinyl alcohol, polyethylene glycol, polyacrylamide, and polyvinyl pyrrolidone, and, in an embodiment, polyvinyl alcohol.

In an embodiment, the inorganic layer may include 70 to 99% by weight, for example, 80 to 90% by weight, of the inorganic material, and 1 to 30% by weight, for example, 10 to 20% by weight, of the binder. Within the above range, the above-described effects of the present invention may be easily achieved.

The coating layer including the inorganic layer surrounds the substrate sheet, and the coating layer may include a first coating layer formed on an upper surface and a lower surface of the substrate sheet; and a second coating layer formed on a side surface of the substrate sheet. The first coating layer and the second coating layer may be formed as different inorganic layers. In an embodiment, the first coating layer and the second coating layer may each have a thickness of 1 μm to 500 μm, for example, 10 μm to 300 μm, or 80 μm to 200 μm. Within the above range, each coating layer may be used in the heat insulating sheet and the battery module.

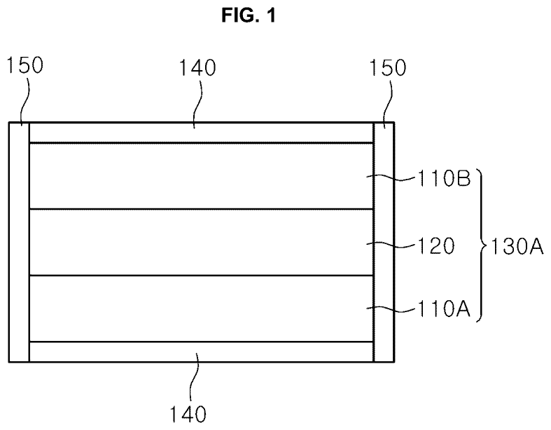

FIG. 1 is a cross-sectional view of a heat insulating sheet for a rechargeable lithium battery according to an embodiment.

Referring to FIG. 1, the heat insulating sheet for a rechargeable lithium battery may include a substrate sheet 130A including a first substrate layer 110A; a second substrate layer 110B facing the first substrate layer 110A; an aerogel-containing layer 120 laminated between the first substrate layer 110A and the second substrate layer 110B; a first coating layer 140 surrounding an upper surface and a lower surface of the substrate sheet 130A; and a second coating layer 150 surrounding side surfaces of the substrate sheet 130A.

Herein, a method of preparing a heat insulating sheet according to an embodiment will be described.

In an embodiment, a method of preparing a heat insulating sheet may include preparing a composition for an aerogel-containing layer including a fibrous support, an aerogel, and a binder; coating a first substrate layer with the composition for an aerogel-containing layer and drying the composition for an aerogel-containing layer coated on the first substrate layer to prepare a substrate sheet; and forming an inorganic layer on the entire surface of the substrate sheet.

The composition for an aerogel-containing layer includes a fibrous support, an aerogel, and a binder. The fibrous support, the aerogel, and the binder may be the same as described above.

The composition for an aerogel-containing layer may further include at least one of the dispersant, the silane-based compound, and the additive described above.

The composition for an aerogel-containing layer may further include a solvent.

The solvent may include at least one of a polar solvent and a non-polar solvent.

The polar solvent may include water, an alcohol-based solvent, or a combination thereof. The water may include, for example, purified water, ultrapure water, or a combination thereof. The alcohol-based solvent may include, for example, at least one of methanol, ethanol, propanol, pentanol, butanol, hexanol, ethylene glycol, propylene glycol, diethylene glycol, and glycerol.

The non-polar solvent may include a hydrocarbon-based solvent. For example, the hydrocarbon-based solvent may include at least one of an aliphatic hydrocarbon solvent, such as hexane, pentane, heptane, and the like, for example, an alkane solvent; an aromatic hydrocarbon solvent, such as toluene, benzene, and the like.

For example, the solvent may include water. If water is used as the solvent, raw material costs and post-processing costs may be effectively reduced.

In an embodiment, the solvent may be included in a weight ratio of 1:1 to 1:90 with respect to the total solid content of the composition for an aerogel-containing layer. In an embodiment, for example, the solvent and the total solid content of the composition for an aerogel-containing layer may have a weight ratio of 1:50 to 1:70, 1:20 to 1:30, or 1:2 to 1:10. Within the above range, the composition for an aerogel-containing layer may be coated by controlling the viscosity of the composition for an aerogel-containing layer.

The composition for an aerogel-containing layer may be prepared using the solvent, the fibrous support, the aerogel, and the binder.

According to an embodiment, the composition for an aerogel-containing layer may be prepared by the following steps: mixing the binder into the solvent to prepare a first mixture; mixing an aerogel into the first mixture to prepare a second mixture; and mixing a fibrous support into the second mixture to prepare a composition for an aerogel-containing layer. In the step of preparing the first mixture, the dispersant, the silane-based compound, the additive, and the like may be further mixed.

In each of the first step, the second step, and the step of preparing the composition for an aerogel-containing layer, the above components may be mixed using a mixer. For example, a planetary mixer, a Thinky mixer, or the like may be used as the mixer.

The planetary mixer may include at least one of one or more planetary blades and one or more high-speed dispersing blades. The planetary blades and the high-speed dispersing blades continuously rotate about their axes. The rotation speed may be expressed in revolutions per minute (rpm).

According to an embodiment, the planetary mixer may include first and second blades having different axes of rotation. For example, the first blades may be low-speed blades, and the second blades may be high-speed blades. Here, the terms “low speed” and “high speed” refer to relative rotational speeds. In an embodiment, the first blades may be open blades, and the second blades may be Despa blades. For example, the rotational speed of the first blades may be 10 to 100 rpm, or 10 to 60 rpm. The rotational speed of the second blades may be 100 to 2,000 rpm.

According to an embodiment, before the drying is performed, a second substrate layer may be further laminated on the coating of the composition for an aerogel-containing layer.

The aerogel-containing layer may be prepared by applying the composition for an aerogel-containing layer and then drying the composition. In an embodiment, the drying may be performed at a temperature of 25° C. to 100° C., 45° C. to 90° C., or 60° C. to 85° C. Within the above range, an aerogel-containing layer having excellent mechanical strength may be formed without a separate adhesive or adhesive member while preventing or substantially preventing peeling between the first substrate layer and the aerogel-containing layer and between the aerogel-containing layer and the second substrate layer.

In an embodiment, the inorganic layer may be prepared by applying a slurry containing the inorganic material to the entire surface of the substrate sheet through coating, spraying, and the like, and drying the slurry.

In an embodiment, the slurry may further include an aqueous solvent or an organic solvent to ensure that the inorganic layer is formed uniformly or substantially uniformly.

In an embodiment, the drying may be performed at a temperature of 25° C. to 100° C., 45° C. to 90° C., or 60° C. to 85° C. Within the above range, an aerogel-containing layer having excellent mechanical strength may be formed without a separate adhesive or adhesive member while preventing or substantially preventing peeling between the substrate sheet and the inorganic layer.

### Rechargeable Lithium Battery Module

According to an embodiment, a rechargeable lithium battery module includes a plurality of battery cells arranged to face each other; and a heat insulating sheet for a rechargeable lithium battery disposed between battery cells of the plurality of battery cells.

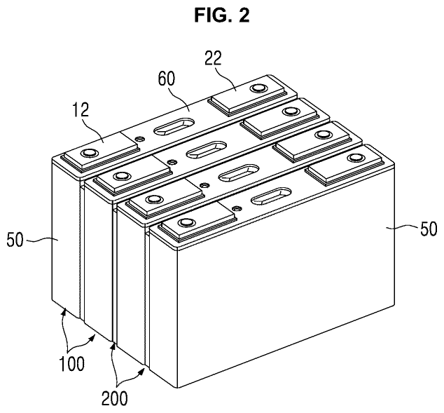

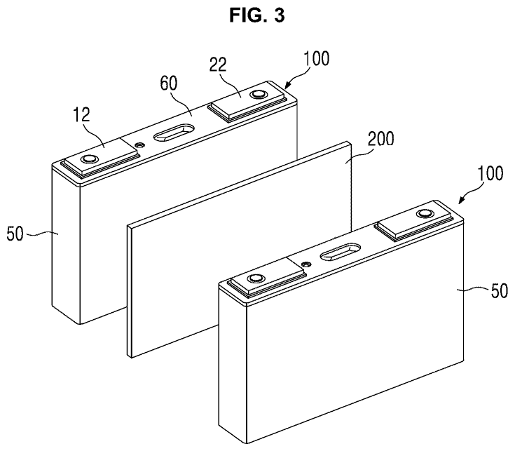

FIGS. 2 and 3 are a perspective view and an exploded perspective view, respectively, of a rechargeable lithium battery module according to an embodiment.

Referring to FIGS. 2 and 3, the rechargeable lithium battery module may include a plurality of battery cells 100 arranged to face each other; and a heat insulating sheet 200 for a rechargeable lithium battery disposed between the battery cells 100.

The heat insulating sheet 200 for a rechargeable lithium battery is in a plate-like shape, wherein a first side of the heat insulating sheet 200 may come into contact with a side of a battery cell 100, and a second side, which is opposite the first side, may come into contact with a side of another battery cell 100.

The battery cell 100 may include a case 50 configured to accommodate an electrode assembly including a positive electrode and a negative electrode; a cap plate 60 coupled with the case 50 to seal the case 50; and a positive electrode terminal 12 and a negative electrode terminal 22 electrically connected to the positive electrode and the negative electrode of the electrode assembly and protruding outward from the cap plate 60.

The positive electrode may include a current collector and a positive electrode active material layer formed on the current collector. The positive electrode active material layer includes a positive electrode active material and may further include a binder and/or a conductive material. In an embodiment, the content of the positive electrode active material may be 90% by weight to 99.5% by weight based on 100% by weight of the positive electrode active material layer, and the content of the binder and the conductive material may each be 0.5% by weight to 5% by weight, based on 100% by weight of the positive electrode active material layer.

In an embodiment, the current collector may be made of Al, but the present invention is not limited thereto.

As the positive electrode active material, a compound capable of reversible intercalation and deintercalation of lithium (a lithiated intercalation compound) may be used. In an embodiment, at least one of a composite oxide of lithium and a metal selected from cobalt, manganese, nickel, and a combination thereof may be used.

The composite oxide may be a lithium transition metal composite oxide, and examples thereof include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any of the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}CO_{c}L¹_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is Ni, Co, Mn, or a combination thereof; Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

The negative electrode includes a current collector and a negative electrode active material layer disposed on the current collector. The negative electrode active material layer includes a negative electrode active material, and may further include a binder and/or a conductive material. In an embodiment, for example, the negative electrode active material layer may include 90% by weight to 99% by weight of the negative electrode active material, 0.5% by weight to 5% by weight of the binder, and 0% by weight to 5% by weight of the conductive material.

The negative electrode active material includes a material capable of reversible intercalation/deintercalation of lithium ions, lithium metal, an alloy of lithium and a metal, a material capable of doping and dedoping lithium, or a transition metal oxide.

The material capable of reversible intercalation/deintercalation of lithium ions may include a carbon-based negative electrode active material, for example, crystalline carbon, amorphous carbon, or a combination thereof. Examples of the crystalline carbon include graphite, such as natural graphite or artificial graphite, and examples of the amorphous carbon include soft carbon or hard carbon, mesophase pitch carbide, calcined coke, and the like.

As the material capable of doping and dedoping lithium, a Si-based negative electrode active material or a Sn-based negative electrode active material may be used. The Si-based negative electrode active material may be silicon, a silicon-carbon composite, SiOₓ (0<x≤2), a Si-Q alloy, or a combination thereof.

The silicon-carbon composite may be a composite of silicon and amorphous carbon. According to an embodiment, the silicon-carbon composite may be in the form of silicon particles of which surfaces are coated with amorphous carbon.

The silicon-carbon composite may further include crystalline carbon. For example, the silicon-carbon composite may include a core including crystalline carbon and silicon particles, and an amorphous carbon coating layer disposed on a surface of the core.

A non-aqueous binder, an aqueous binder, a dry binder, or a combination thereof may be used as the binder. If the aqueous binder is used as the negative electrode binder, the aqueous binder may further include a cellulose-based compound capable of imparting viscosity.

In an embodiment, a current collector selected from any of copper foil, nickel foil, stainless steel foil, titanium foil, nickel foam, copper foam, a polymer substrate coated with a conductive metal, and a combination thereof may be used as the negative electrode current collector.

An electrolyte for a rechargeable lithium battery may include a non-aqueous organic solvent and a lithium salt.

The non-aqueous organic solvent acts as a medium through which ions involved in the electrochemical reaction of the battery may move. The non-aqueous organic solvent may be a carbonate-based, ester-based, ether-based, ketone-based, or alcohol-based solvent, an aprotic solvent, or a combination thereof, which may be used alone or in combination of two or more thereof.

In an embodiment, if the carbonate solvent is used, a cyclic carbonate and a chain carbonate may be used in combination.

A separator may be present between the positive electrode and the negative electrode depending on the type of rechargeable lithium battery. As such a separator, polyethylene, polypropylene, polyvinylidene fluoride, or a multi-layer film of two or more layers thereof may be used.

The separator may include a porous substrate and a coating layer including an organic material, an inorganic material, or a combination thereof and disposed on one or both, or opposite, surfaces of the porous substrate.

In an embodiment, the organic material may include a polyvinylidene fluoride-based polymer or a (meth)acrylic polymer. The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the present invention is not limited thereto. The organic and inorganic materials may be present as a mixture in one coating layer, or may be present in a form in which a coating layer including the organic material and a coating layer including the inorganic material are laminated.

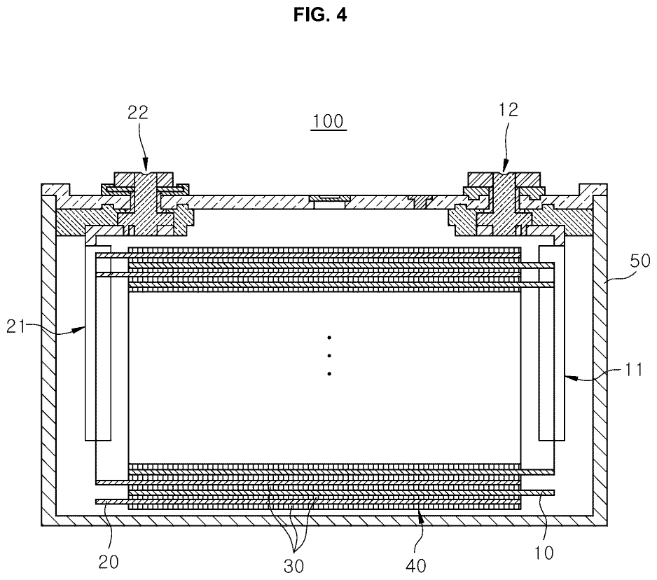

FIG. 4 is a cross-sectional view schematically showing a battery cell 100 according to an embodiment.

Referring to FIG. 4, the battery cell 100 may include an electrode assembly 40 having a positive electrode 10, a negative electrode 20, and a separator 30 interposed between the positive electrode 10 and the negative electrode 20; a case 50 configured to accommodate the electrode assembly 40; a positive electrode lead tab 11 connected to the positive electrode 10; a positive electrode terminal 12 connected to the positive electrode lead tab 11; a negative electrode lead tab 21 connected to the negative electrode 20; and a negative electrode terminal 22 connected to the negative electrode lead tab 21.

The rechargeable lithium battery module according to one or more embodiments may be applied to automobiles, mobile phones, and/or various types of electrical devices, but the present invention is not limited thereto.

The rechargeable lithium battery module according to the embodiment described above may be used to manufacture a battery pack.

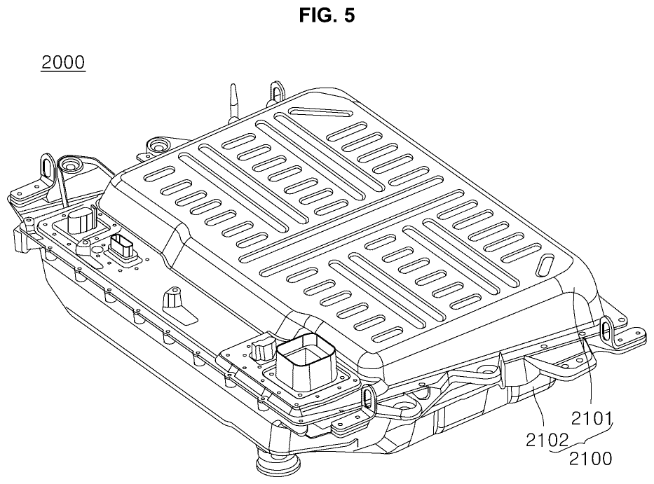

FIG. 5 is a diagram showing a battery pack according to an embodiment.

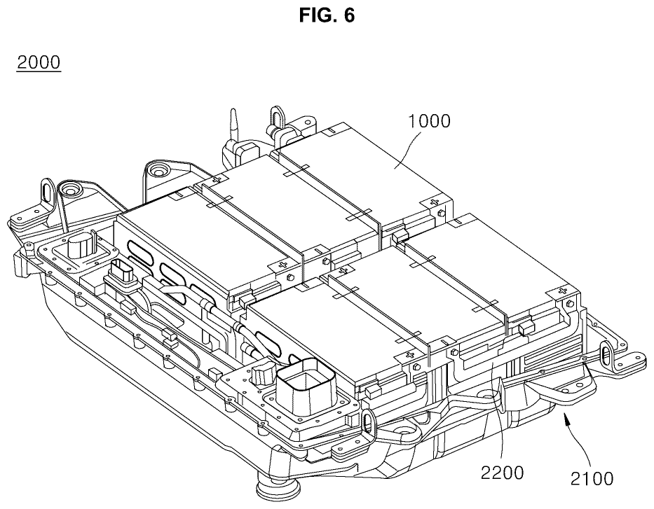

FIG. 6 is a diagram showing a battery pack according to an embodiment.

A battery pack 2000 according to an embodiment includes an assembly of individual batteries electrically connected to each other and a pack case configured to accommodate the batteries. For convenience of illustration in the drawings, parts for electrical connection between batteries, such as bus bars, cooling units, and external terminals, are not shown.

The battery pack 2000 may include a plurality of battery modules 1000 (for example, the battery module described with respect to FIGS. 2 and 3) and a pack case 2100 configured to accommodate the battery modules 1000. In an embodiment, for example, the pack case 2100 may include first and second pack cases 2101 and 2102 coupled in a direction facing each other with the plurality of battery modules 1000 interposed therebetween. The plurality of battery modules 1000 may be electrically connected to each other using a bus bar 2200, and the plurality of battery modules 1000 may be electrically connected to each other in a series/parallel or series-parallel hybrid manner to obtain a desired electrical output.

The battery pack 2000 according to an embodiment described in FIGS. 5 and 6 may be mounted on a vehicle 3000. The vehicle 3000 may be, for example, an electric vehicle, a hybrid vehicle, or a plug-in hybrid vehicle. The vehicle may include a four-wheel vehicle or a two-wheel vehicle.

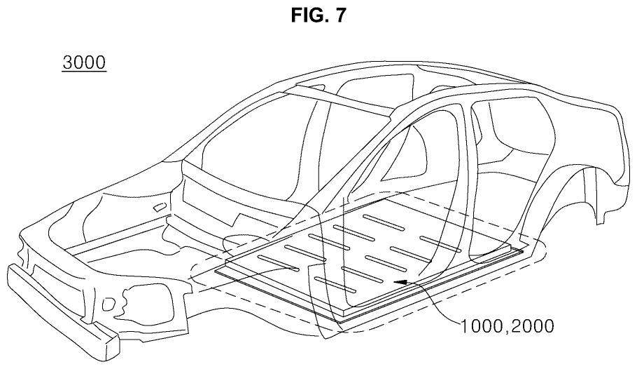

FIG. 7 is a diagram showing a car body and car body parts according to an embodiment.

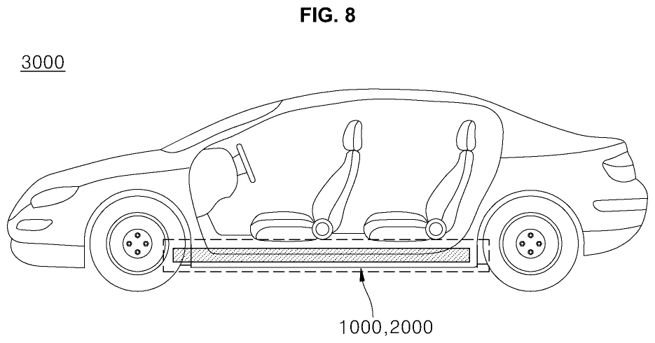

FIG. 8 is a diagram showing a car body and car body parts according to an embodiment.

As shown in FIGS. 7 and 8, a vehicle 3000 according to an embodiment includes a battery module 1000 according to an embodiment of the present invention and/or a battery pack 2000 including the battery module 1000. The vehicle 3000 operates by receiving power from the battery module 1000 according to an embodiment of the present invention and/or the battery pack 2000 including the battery module 1000.

Herein, examples and comparative examples of the present invention will be described. However, it is to be understood that the following examples are provided only as examples of the present invention, and are not intended to limit the present invention.

### Example 1

### Preparation of Composition for Aerogel-Containing Layer

Polyvinyl alcohol (Sigma-Aldrich, PVA) as a binder was added to ultrapure water, which is a solvent, and sequentially mixed at 30 rpm with an open blade and 700 rpm with a Despa blade to prepare a first mixture. An aerogel (having a BET specific surface area of 800 m²/g) was added to the first mixture, and sequentially mixed at 70 rpm with an open blade and 1,500 rpm with a Despa blade to prepare a second mixture. Glass wool as a fibrous support was added to the second mixture, and sequentially mixed at 30 rpm with an open blade and 1,200 rpm with a Despa blade to prepare a composition for an aerogel-containing layer. A planetary mixer (Dientech, PT-005) was used during mixing.

The prepared composition for an aerogel-containing layer is in the form of a slurry, and the composition includes 50% by weight of aerogel, 40% by weight of glass wool, and 10% by weight of polyvinyl alcohol based on solid content.

### Preparation of Heat Insulating Sheet

The first substrate layer included a glass fiber sheet having a thickness of 1 mm (gsm: 100), the prepared composition for an aerogel-containing layer was applied onto the first substrate layer, and a second substrate layer including a glass fiber sheet having a thickness of 1 mm (gsm: 100) was laminated on the composition for an aerogel-containing layer, and coated by a roll rolling method. Thereafter, the resulting laminate was dried at 60° C. for 24 hours to prepare a substrate sheet in which the glass fiber sheet, the aerogel-containing layer, and the glass fiber sheet were laminated in this order.

Polyvinyl alcohol (Sigma-Aldrich, PVA) as a binder was added to ultrapure water, which is a solvent, and mixed with an alumina (average particle size D50: 500 nm) sol to prepare a composition for a first coating layer. Thereafter, the upper and lower surfaces of the substrate sheet were uniformly coated with the composition for a first coating layer through bar coating. Then, the composition was dried at 60° C. for 24 hours to prepare a heat insulating sheet in which the polyvinyl alcohol- and alumina-containing coating layer were formed on the upper and lower surfaces of the substrate sheet. The composition for a first coating layer was in the form of a slurry, and included 90% by weight of alumina and 10% by weight of polyvinyl alcohol based on solid content.

Also, polyvinyl alcohol (Sigma-Aldrich, PVA) as a binder was added to ultrapure water, which is a solvent, and mixed with a silica (average particle size D50: 500 nm) sol to prepare a composition for a second coating layer, and the side of the substrate sheet was dip-coated into the prepared composition for a second coating layer. Thereafter, the composition was dried at 60° C. for 24 hours to prepare a heat insulating sheet in which the polyvinyl alcohol- and silica-containing coating layer were formed on the side of the substrate sheet. The composition for a second coating layer was in the form of a slurry, and included 90% by weight of silica and 10% by weight of polyvinyl alcohol based on solid content.

In the prepared heat insulating sheet, the aerogel-containing layer had a thickness of 2,000 μm, and the coating layer had a thickness of 100 μm.

### Example 2

A heat insulating sheet was prepared in the same manner as in Example 1, except that the composition for a second coating layer was in the form of a slurry and included 90% by weight of alumina and 10% by weight of polyvinyl alcohol based on solid content.

### Example 3

A heat insulating sheet was prepared in the same manner as in Example 1, except that the composition for a first coating layer was in the form of a slurry and included 90% by weight of silica and 10% by weight of polyvinyl alcohol based on solid content, and the composition for a second coating layer was in the form of a slurry and included 90% by weight of alumina and 10% by weight of polyvinyl alcohol.

### Example 4

A heat insulating sheet was prepared in the same manner as in Example 1, except that the composition for a first coating layer was in the form of a slurry and included 90% by weight of silica and 10% by weight of polyvinyl alcohol based on solid content.

### Example 5

A heat insulating sheet was prepared in the same manner as in Example 1, except that the first substrate layer included a carbon fiber sheet having a thickness of 1 mm (gsm: 80), and the second substrate layer included a carbon fiber sheet having a thickness of 1 mm (gsm: 80).

### Example 6

A heat insulating sheet was prepared in the same manner as in Example 1, except that the first substrate layer included a carbon fiber sheet having a thickness of 1.5 mm (gsm: 120), and the second substrate layer included a carbon fiber sheet having a thickness of 1.5 mm (gsm: 120).

### Example 7

A heat insulating sheet was prepared in the same manner as in Example 1, except that the second substrate layer included a carbon fiber sheet having a thickness of 1 mm (gsm: 80).

### Example 8

A heat insulating sheet was prepared in the same manner as in Example 1, except that the aerogel-containing layer had a thickness of 3,000 μm.

### Example 9

A heat insulating sheet was prepared in the same manner as in Example 1, except that the first substrate layer included a glass fiber sheet having a thickness of 3 mm (gsm: 150), and the second substrate layer included a glass fiber sheet having a thickness of 3 mm (gsm: 150).

### Example 10

A heat insulating sheet was prepared in the same manner as in Example 1, except that the first substrate layer included a carbon fiber sheet having a thickness of 2 mm (gsm: 120), and the second substrate layer included a carbon fiber sheet having a thickness of 2 mm (gsm: 120).

### Comparative Example 1

A substrate sheet was prepared in the same manner as in Example 1, except that the first substrate layer and the second substrate layer included a glass fiber sheet (gsm: 30).

### Comparative Example 2

A substrate sheet was prepared in the same manner as in Example 1, except that the first substrate layer and the second substrate layer each included a glass fiber sheet having a thickness of 1.5 mm (gsm: 600).

### Comparative Example 3

A substrate sheet was prepared in the same manner as in Example 5, except that the first substrate layer and the second substrate layer each included a carbon fiber sheet (gsm: 30).

### Comparative Example 4

A substrate sheet was prepared in the same manner as in Example 5, except that the first substrate layer and the second substrate layer each included a carbon fiber sheet having a thickness of 1.5 mm (gsm: 500).

### Comparative Example 5

A substrate sheet was prepared in the same manner as in Example 1, except that a mica sheet was used in each of the first substrate layer and the second substrate layer.

### Comparative Example 6

A substrate sheet was prepared in the same manner as in Example 1, except that the aerogel-containing layer had a thickness of 200 μm.

### Comparative Example 7

A substrate sheet was prepared in the same manner as in Example 1, except that each of the first substrate layer and the second substrate layer had a thickness of 6.5 mm.

### Comparative Example 8

A substrate sheet was prepared in the same manner as in Example 1, except that the aerogel-containing layer had a thickness of 2 μm.

The physical properties were evaluated for the heat insulating sheets prepared in the examples and comparative examples, as follows.

(1) grams per square meter (gsm): A glass fiber sheet or carbon fiber sheet was cut to prepare a specimen, and the width and height of the prepared specimen were measured to calculate the area (m²). Thereafter, the weight (g) of the prepared specimen was measured using a scale.

gsm=Weight of specimen (g)/Area of specimen (m²)

(2) Heat insulating properties (units: ° C.): The prepared heat insulating sheet was cut into pieces with a length of 232 mm and a width of 115 mm to prepare specimens, and each of the specimens was placed between a pair of opposing aluminum plates having a thickness of 1 mm. Thereafter, each specimen was placed on a heat press, and an upper plate of the heat press was heated to 350° C. and a lower plate of the heat press was not heated and maintained at the starting temperature of 40° C. Then, a pressure of 20 kN was applied to the lower plate of the heat press, and the temperature of the lower plate of the heat press was measured after 11 minutes. The lower the temperature of the lower plate, the better the heat insulating properties of the heat insulating sheet.

(3) Dust resistance (units: %): The prepared heat insulating sheet was cut into length×width (12 inches×12 inches) to prepare a specimen, and the weight of the specimen was measured. The specimen was vibrated under vibration conditions (frequency: 24 Hz/3 mm, vibration time: 6 hours) using a vibration tester (ASTM C592-04), and the weight of the specimen was then measured. Thereafter, the weight reduction rate was evaluated using the following equation.

Weight reduction rate=[(Weight of specimen before vibration)−(Weight of specimen after vibration)]/(Weight of specimen before vibration)×100.

(4) Resistance to flame passage (units: seconds): The prepared heat insulating sheet was cut into a length of 100 mm and a width of 70 mm to prepare a specimen, and a temperature sensor was mounted on the specimen. A flame was applied to the surface of the specimen using a torch capable of ejecting a flame so that the temperature of the surface of the specimen reached 1,200° C. At this time, the time until the specimen collapsed as cracks occurred on the exterior of the specimen was checked. The longer the time, the better the resistance to flame passage.

(5) Compressibility (units: %): The prepared heat insulating sheet was cut into a length of 232 mm and a width of 115 mm to prepare a specimen, and the specimen was placed between aluminum plates having a thickness of 1 mm while setting the zero point using UTM equipment. Thereafter, a compression test was conducted by measuring a change in thickness when compressed at a compression speed of 0.02 mm/sec from 0 MPa to 0.6 MPa. At this time, the compressibility was expressed using the thickness reduction rate at 0.55 MPa based on the thickness at 0 MPa.

TABLE 1

| | Aerogel- | First substrate layer | | | Second substrate layer | | | | | | | | |
|---|---|---|---|---|---|---|---|---|---|---|---|---|---|
| | containing | Glass | Carbon | | Glass | Carbon | | | | Heat | | | |
| | layer | fiber | fiber | | fiber | fiber | | First | Second | insulation | Dust | | Compress- |
| | Thickness | sheet | sheet | Thickness | sheet | sheet | Thickness | coating | coating | properties | resistance | Resistance | ibility |
| | (μm) | (gsm) | (gsm) | (μm) | (gsm) | (gsm) | (μm) | layer | layer | (° C.) | (%) | (sec) | (%) |
| Exam- | 2,000 | 100 | 0 | 1,000 | 100 | 0 | 1,000 | Alumina | Silica | 80.3 | 0.00 | 612 | 32.8 |
| ple 1 | | | | | | | | | | | | | |
| Exam- | 2,000 | 100 | 0 | 1,000 | 100 | 0 | 1,000 | Alumina | Alumina | 81.2 | 0.00 | 619 | 33.3 |
| ple 2 | | | | | | | | | | | | | |
| Exam- | 2,000 | 100 | 0 | 1,000 | 100 | 0 | 1,000 | Silica | Alumina | 80.5 | 0.00 | 603 | 32.6 |
| ple 3 | | | | | | | | | | | | | |
| Exam- | 2,000 | 100 | 0 | 1,000 | 100 | 0 | 1,000 | Silica | Silica | 80.3 | 0.00 | 602 | 33.1 |
| ple 4 | | | | | | | | | | | | | |
| Exam- | 2,000 | 0 | 80 | 1,000 | 0 | 80 | 1,000 | Alumina | Silica | 81.4 | 0.00 | 635 | 32.1 |
| ple 5 | | | | | | | | | | | | | |
| Exam- | 2,000 | 0 | 120 | 1,500 | 0 | 120 | 1,500 | Alumina | Silica | 79.4 | 0.00 | 644 | 34.2 |
| ple 6 | | | | | | | | | | | | | |
| Exam- | 2,000 | 100 | 0 | 1,000 | 0 | 80 | 1,000 | Alumina | Silica | 80.4 | 0.00 | 615 | 32.7 |
| ple 7 | | | | | | | | | | | | | |
| Exam- | 3,000 | 100 | 0 | 1,000 | 100 | 0 | 1,000 | Alumina | Silica | 76.8 | 0.00 | 621 | 31.8 |
| ple 8 | | | | | | | | | | | | | |
| Exam- | 2,000 | 150 | 0 | 3,000 | 150 | 0 | 3,000 | Alumina | Silica | 79.2 | 0.00 | 625 | 34.3 |
| ple 9 | | | | | | | | | | | | | |
| Exam- | 2,000 | 0 | 120 | 2,000 | 0 | 120 | 2,000 | Alumina | Silica | 80.2 | 0.00 | 648 | 34.9 |
| ple 10 | | | | | | | | | | | | | |
| Comp. | 2,000 | 30 | 0 | 1,000 | 30 | 0 | 1,000 | Alumina | Silica | 81.5 | 0.14 | 582 | 10.2 |
| Exam- | | | | | | | | | | | | | |
| ple 1 | | | | | | | | | | | | | |
| Comp. | 2,000 | 600 | 0 | 1,500 | 600 | 0 | 1,500 | Alumina | Silica | 79.5 | 0.00 | 663 | 9.3 |
| Exam- | | | | | | | | | | | | | |
| ple 2 | | | | | | | | | | | | | |
| Comp. | 2,000 | 0 | 30 | 1,000 | 0 | 30 | 1,000 | Alumina | Silica | 82.2 | 0.12 | 593 | 12.2 |
| Exam- | | | | | | | | | | | | | |
| ple 3 | | | | | | | | | | | | | |
| Comp. | 2,000 | 0 | 500 | 1,500 | 0 | 500 | 1,500 | Alumina | Silica | 8.6 | 0.00 | 693 | 10.1 |
| Exam- | | | | | | | | | | | | | |
| ple 4 | | | | | | | | | | | | | |
| Comp. | 2,000 | 0 | 0 | 1,000 | 0 | 0 | 1,000 | Alumina | Silica | 80.1 | 0.00 | 723 | 8.3 |
| Exam- | | | | | | | | | | | | | |
| ple 5 | | | | | | | | | | | | | |
| Comp. | 200 | 100 | 0 | 1,000 | 100 | 0 | 1,000 | Alumina | Silica | 94.2 | 0.00 | 532 | 33.3 |
| Exam- | | | | | | | | | | | | | |
| ple 6 | | | | | | | | | | | | | |
| Comp. | 2,000 | 100 | 0 | 6,500 | 100 | 0 | 6,500 | Alumina | Silica | 81.1 | 0.00 | 615 | 12.1 |
| Exam- | | | | | | | | | | | | | |
| ple 7 | | | | | | | | | | | | | |
| Comp. | 2 | 100 | 0 | 1,000 | 100 | 0 | 1,000 | Alumina | Silica | 102.7 | 0.00 | 431 | 34.9 |
| Exam- | | | | | | | | | | | | | |
| ple 8 | | | | | | | | | | | | | |

As shown in Table 1 above, the heat insulating sheets of the Examples provided excellent heat insulating properties, excellent dust resistance, excellent heat resistance and durability, and excellent compressibility.

On the other hand, the heat insulating sheets of Comparative Examples 1 to 8 had poor dust resistance, poor heat resistance and durability, or poor compressibility.

Although the present invention has been described above with reference to some embodiments thereof, the present invention is not limited thereto. Therefore, it is to be understood that various changes and modifications can be made by those skilled in the art to which the present invention pertains within the scope of the claims, the detailed description of the present invention, and the accompanying drawings, which also fall within the scope of the present invention.

What is claimed is:

1. A heat insulating sheet for a rechargeable lithium battery, the heat insulating sheet comprising:
a substrate sheet comprising a first substrate layer, an aerogel-containing layer, and a second substrate layer, which are sequentially laminated; and
a coating layer surrounding the substrate sheet,
wherein each of the first substrate layer and the second substrate layer comprises one selected from the group consisting of a glass fiber sheet having a weight of 70 to 500 grams per square meter (gsm); and a carbon fiber sheet having a weight of 50 to 300 gsm,
each of the first substrate layer and the second substrate layer has a thickness of 300 μm to 5,000 μm,
the aerogel-containing layer has a thickness of 300 μm to 5,000 μm, and
the aerogel is included in an amount of 10 to 90% by weight in the aerogel-containing layer.

2. The heat insulating sheet as claimed in claim 1, wherein the aerogel-containing layer is a non-continuous layer that is separate from the first substrate layer.

3. A rechargeable lithium battery module comprising:
a plurality of battery cells arranged to face each other; and
the heat insulating sheet for a rechargeable lithium battery of claim 2 arranged between battery cells of the plurality of battery cells.

4. The heat insulating sheet as claimed in claim 1, wherein the aerogel-containing layer is a non-continuous layer that is separate from the second substrate layer.

5. A rechargeable lithium battery module comprising:
a plurality of battery cells arranged to face each other; and
the heat insulating sheet for a rechargeable lithium battery of claim 4 arranged between battery cells of the plurality of battery cells.

6. The heat insulating sheet as claimed in claim 1, wherein the coating layer comprises a first coating layer on an upper surface and a lower surface of the substrate sheet; and a second coating layer on a side surface of the substrate sheet, and
the first coating layer and the second coating layer are made of different inorganic layers.

7. The heat insulating sheet as claimed in claim 6, wherein each of the first coating layer and the second coating layer has a thickness of 1 μm to 500 μm.

8. A rechargeable lithium battery module comprising:
a plurality of battery cells arranged to face each other; and
the heat insulating sheet for a rechargeable lithium battery of claim 7 arranged between battery cells of the plurality of battery cells.

9. The heat insulating sheet as claimed in claim 6, wherein the inorganic layers in the first coating layer and the second coating layer are layers comprising at least one of silicon oxide and aluminum oxide.

10. A rechargeable lithium battery module comprising:
a plurality of battery cells arranged to face each other; and
the heat insulating sheet for a rechargeable lithium battery of claim 9 arranged between battery cells of the plurality of battery cells.

11. The heat insulating sheet as claimed in claim 6, wherein the inorganic layer further comprises a binder.

12. The heat insulating sheet as claimed in claim 11, wherein the binder comprises at least one of polyvinyl alcohol, polyethylene glycol, polyacrylamide, polyvinyl pyrrolidone, polyurethane, and polyester.

13. A rechargeable lithium battery module comprising:
a plurality of battery cells arranged to face each other; and
the heat insulating sheet for a rechargeable lithium battery of claim 12 arranged between battery cells of the plurality of battery cells.

14. A rechargeable lithium battery module comprising:
a plurality of battery cells arranged to face each other; and
the heat insulating sheet for a rechargeable lithium battery of claim 11 arranged between battery cells of the plurality of battery cells.

15. A rechargeable lithium battery module comprising:
a plurality of battery cells arranged to face each other; and
the heat insulating sheet for a rechargeable lithium battery of claim 6 arranged between battery cells of the plurality of battery cells.

16. A rechargeable lithium battery module comprising:
a plurality of battery cells arranged to face each other; and
the heat insulating sheet for a rechargeable lithium battery of claim 1 arranged between battery cells of the plurality of battery cells.
